(19) United States
(12) Patent Application Publication
(10) Pub. No.: US 2010/0229216 A1
(43) Pub. Date: Sep. 9, 2010

(54) WIRELESS CONNECTION DEVICE

(75) Inventor: Kifumi Koga, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/782,049

(22) Filed: May 18, 2010

Related U.S. Application Data
(63) Continuation of application No. PCT/JP2007/072745, filed on Nov. 26, 2007.

(51) Int. Cl. H04J 3/08; G06F 21/00

(52) U.S. Cl. 726/3; 370/315

(57) ABSTRACT

A wireless connection device includes a unit to perform communications with another wireless connection device; a unit to transmit a wireless device guide packet to a wireless device and to accept an access request from said wireless device; and a control unit that includes a unit to receive a proxy request containing identifying information for identifying another wireless connection device when in wireless communications from said another wireless connection device; a packet generating unit to generate a proxy packet as a substitute for the wireless device guide packet sent from said another wireless connection device serving as a sender of this wireless device guide packet by use of the received identifying information; a unit to transmit the proxy packet via said wireless communication unit; a unit to accept a request for the connection to said wireless network system from said wireless device; and a forwarding unit to forward the connection request to said another wireless connect ion device when the accepted connection request is a connection request addressed to said another wireless connection device.

### CROSS-REFERENCE TO RELATED APPLICATION

This is a continuation of Application PCT/JP2007/072745, filed on Nov. 26, 2007, now pending, the entire contents of which are herein wholly incorporated by reference.

### FIELD

The present invention relates to an authentication process at a wireless LAN access point which is requested by a wireless communication device to establish a connection.

### BACKGROUND

A wireless LAN (Local Area Network) is characterized by a general-purpose and a low cost of its system and is anticipated to spread considerably by way of a communication system for a mobile terminal in terms of flexibility of a position of installing the terminal. Normally, in the case of operating the wireless LAN in which the mobile terminal serves as a client in an area having a breadth to some extent, a plurality of access points is installed, and SSIDs (Service Set IDs) of the respective access points are equalized. Then, when the wireless LAN terminal physically moves, a connection destination is properly switched over to the access point that is most suited to the connection, thereby keeping a communication quality. This operation is called “roaming”.

In the wireless LAN network using 802.11i (WPA2) which requires RADIUS authentication for authenticating a connection of the wireless LAN, the wireless LAN terminal can previously conduct the RADIUS authentication with respect to a roaming target access point before roaming by a method known as “Pre Authentication” (which will hereinafter be referred to as a pre-authentication process) in order to speedup resumption of post-roaming communications. FIG. 1 illustrates an outline of the conventional processing.

The pre-authentication process is the process that the wireless LAN terminal performs, when detecting a Beacon packet (which will hereinafter be also termed a terminal guide packet) periodically transmitted by another access point, the authentication for establishing the wireless LAN connection, such as the RADIUS authentication, with respect to a currently-not-yet-connected access point via a currently-connected access point. Therefore, if the wireless LAN terminal does not exist within the area where the terminal guide packet transmitted by another access point can not be received, it is impossible to utilize the pre-authentication process.

[Patent document 1] Japanese Patent Laid-Open Publication No. 2006-339925

[Patent document 2] Japanese Patent Laid-Open Publication No. 2005-86623

The conventional pre-authentication process is a process that is realizable when the terminal guide packet can be received from the plurality of access points, i.e., when communication-enables areas with the access points mutually include an overlapped segment. Such being the case, there is provided a technology of expanding an area to which the pre-authentication process can be applied by relaxing restrictions to the pre-authentication process in terms of the communication-enabled area. It should be noted that such a subject is not limited to the access point on the wireless LAN but a general subject to wireless connection devices on the wireless network which supports the pre-authentication process.

### SUMMARY

This technology is realized by, e.g., a wireless connection device included in a wireless network system. The wireless connection device includes a point-to-point communication unit to perform communications with another wireless connection device, a wireless communication unit to transmit a wireless device guide packet to an address of a wireless device and to accept an access request from the wireless device; and a control unit. Further, the control unit includes: a unit to receive a proxy request containing identifying information for identifying another wireless connection device when in wireless communications from the another wireless connection device via the point-to-point communication unit; packet generating a unit to generate a proxy packet as a substitute for the wireless device guide packet sent from the another wireless connection device serving as a sender of this wireless device guide packet by use of the received identifying information; transmitting a unit to transmit the proxy packet via the wireless communication unit; a unit to accept a request for the connection to the wireless network system from the wireless device; and forwarding a unit to forward the connection request to the another wireless connection device via the point-to-point communication unit when the accepted connection request is a connection request addressed to the another wireless connection device.

This wireless connection device transmits the proxy packet as the substitute for the terminal guide packet sent from another wireless connection device defined as the sender wireless connection device, and hence it follows that the terminal guide packet is transmitted in place of another wireless connection device even in a range that the terminal guide packet sent from another wireless connection device does not reach.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an explanatory diagram illustrating an outline of a conventional pre-authentication process;

FIG. 2 is an explanatory diagram illustrating an outline of processing of a communication system according to one embodiment;

FIG. 3 is a diagram of connections in the communication system;

FIG. 4 is a diagram illustrating a hardware configuration of an access point;

FIG. 5 is a diagram illustrating function blocks of the access point;

FIG. 6 is a diagram illustrating a data structure of a notification packet;

FIG. 7 is a diagram illustrating a structure of a destination address field of an authentication packet;

FIG. 8 is a flowchart illustrating a process of transmitting a proxy packet in the access point;

FIG. 9 is a flowchart illustrating the process of transmitting a notification packet in the access point;

FIG. 10 is a flowchart illustrating a processing flow of the pre-authentication process;

FIG. 11 is a flowchart illustrating a processing flow of the access point which transmits the proxy packet in place of a specified access point;

FIG. 12 is a flowchart illustrating a process of attaching an area ID to the notification packet;

FIG. 13 is a flowchart illustrating a process of an access point A which transmits the proxy packet in place of a notification packet sender after checking a time difference; and

FIG. 14 is a flowchart illustrating a process of attaching a transmission time to the notification packet.

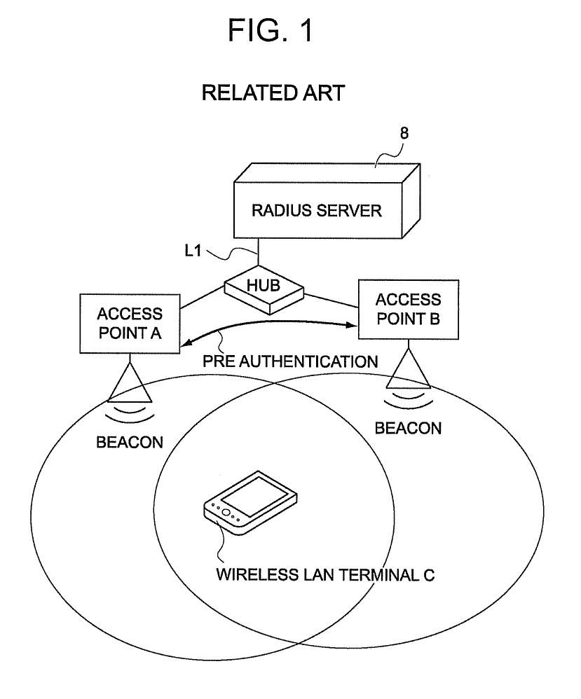

### DESCRIPTION OF EMBODIMENT(S)

A communication system according to a best mode (which will hereinafter be termed an embodiment) for carrying out the present invention will hereinafter be described with reference to the drawings. A configuration in the following embodiment is an exemplification, and the present invention is not limited to the configuration in the embodiment.

<Outline of System>

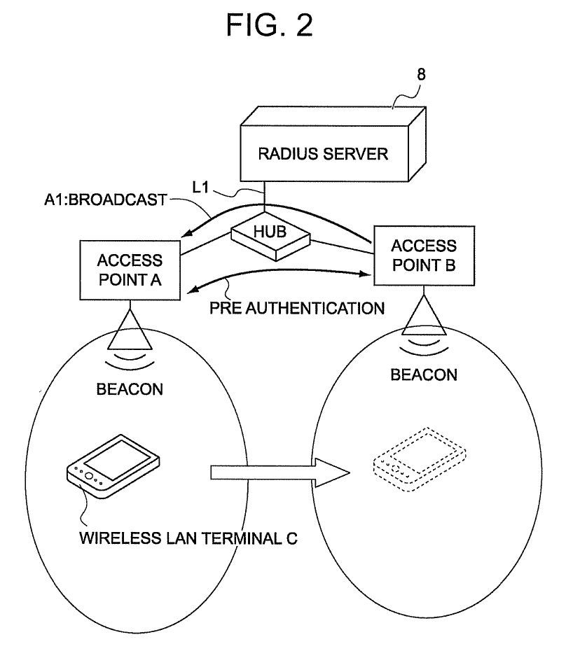

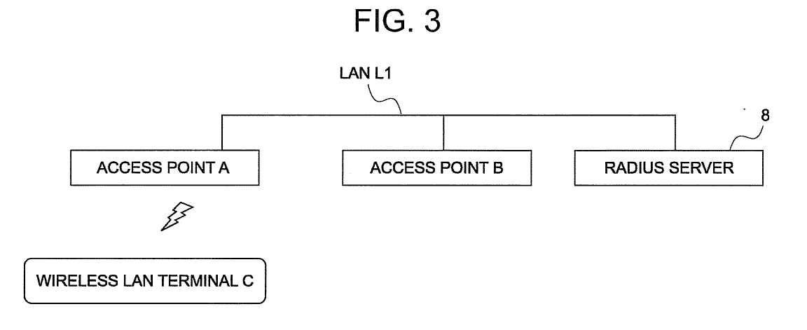

FIG. 2 illustrates an outline of processing of the communication system. Further, FIG. 3 illustrates an outline of a network architecture of this communication system. The communication system includes a plurality of access points A, B, a RADIUS server 8 which authenticates a wireless LAN terminal C etc in response to requests given from the access points A, B (corresponding to wireless connection devices), and a cable LAN L1 which connects the access points A, B and the RADIUS server 8 to each other. Herein, the cable LAN L1 is, e.g., a general type of network including a HUB. Moreover, in FIGS. 2 and 3, a typical mobile body having an access to the communication system is exemplified by the wireless LAN terminal C (corresponding to a wireless device). It should be noted that the terminal is also referred to as a client in the embodiment. The discussion will hereinafter be made by exemplifying the access points A, B and the wireless LAN terminal C. The communication system is not, however, restricted by a combination of the number of access points and the number of the wireless LAN terminals C (the wireless LAN corresponds to a wireless network).

In each of the access points A and B, a wireless communication unit transmits a Beacon packet at a predetermined interval. The Beacon packet contains information for specifying the sender access point A etc and SSID (Service Set ID) defined as information for specifying an authentication method etc of the access point A itself. The present communication system exemplifies a process between the plurality of access points undergoing common settings by way of the SSID.

The wireless LAN terminal C, when receiving a Beacon packet, determines from the SSID of the Beacon packet whether the access point A etc is a connectable access point or not. Then, the wireless LAN terminal C transmits an authentication request to, e.g., the connectable access point A. Thereupon, the access point A receiving the authentication request, requests the RADIUS server 8 to authenticate the wireless LAN terminal C. When acquiring the authentication from the RADIUS server 8, the access point A permits the wireless LAN terminal C to connect with the wireless LAN.

An outline of the processing of the communication system will hereinafter be described.

(1) For example, the access point B periodically (e.g., at an interval of 3 min) broadcasts its own information, serving as a “notification packet”, contained in the Beacon packet to the cable LAN L1. The notification packet contains a MAC (Media Access Control) address for identifying the access point B on the wireless LAN. Thereby, the access point B gets another access point to recognize its own existence, which is connected to a segment of the cable LAN L1 (arrowhead A1).

(2) The access point A, when receiving the “notification packet” transmitted by the access point B, transmits absolutely the same Beacon packet (which will hereinafter be referred to as a proxy packet) as the packet transmitted by the access point B for a fixed period of time (e.g., 5 min) by the wireless communication unit in parallel with the Beacon transmission of the access point A itself. Further, the “transmission of the proxy packet” is referred to as “proxy transmission”. The “proxy transmission” may also be said to be “agency transmission”. Herein, a phrase “in parallel” connotes transmitting the Beacon packet of the access point A itself and the proxy packet on a time-division basis.

At this time, the access point A may retain “reception signal intensity information of radio waves of the Beacon packet of another access point existing in the vicinity”, which is collected in a way that scans states of the ambient radio waves previously by itself. In this case, as a result of referring to the information, if the information contains the access point B and has a record of a reception signal intensity that is equal to or larger than a fixed value, the access point A may inhibit the transmission of the proxy packet of the access point B. This is because the access point A in this case can decide that the access point B exists close to the access point A itself, and hence, without any transmission of the proxy packet, the access point B itself can transmit the Beacon packet to the wireless LAN terminal C.

(3) Now, it is assumed that the wireless LAN terminal C is kept in connection with the access point A and physically exists outside a range of the radio waves transmitted by the access point B. The wireless LAN terminal C, however, recognizes the existence of the access point B by receiving the proxy packet defined as the “Beacon packet of the access point B”, which is transmitted by the access point A.

(4) The wireless LAN terminal C determines from the SSID contained in the proxy packet whether or not the setting of the access point B is coincident with the connection setting of the terminal C itself. Then, if coincident with each other, the wireless LAN terminal C executes a pre-authentication process with respect to the access point B via the access point A. Namely, the pre-authentication request given from the wireless LAN terminal C is forwarded to the access point B from the access point A. The access point B, which has received the forwarded pre-authentication request, requests the RADIUS server 8 for the authentication process by transmitting the MAC address etc of the wireless LAN terminal C to the server 8. This procedure is defined in 802.11i (WPA2), and hence an in-depth description thereof is omitted. After succeeding in the authentication, information indicating the success in the authentication is saved in the access point B.

(5) After the wireless LAN terminal C has succeeded in the pre-authentication process with respect to the access point B and when this terminal C moves and enters the reception-enabled range of the radio waves transmitted from the access point B, the connection process is completed without the RADIUS authentication.

According to the process described above, the wireless LAN terminal C becomes capable of executing the pre-authentication process with respect to the access point (e.g., B) that the radio waves physically can reach. For this reason, the post-roaming RADIUS authentication is omitted, and hence the post-roaming communication resumes much faster than the case disabling the pre-authentication process from being executed. In other words, there expands an area to which the pre-authentication process can be applied. Further, the futile Beacon transmission is restrained by performing the control of not conducting the proxy transmission of the Beacon to the near-existing access point, thus enabling usage efficiency of the radio frequency band to be increased.

<Configuration of Access Point>

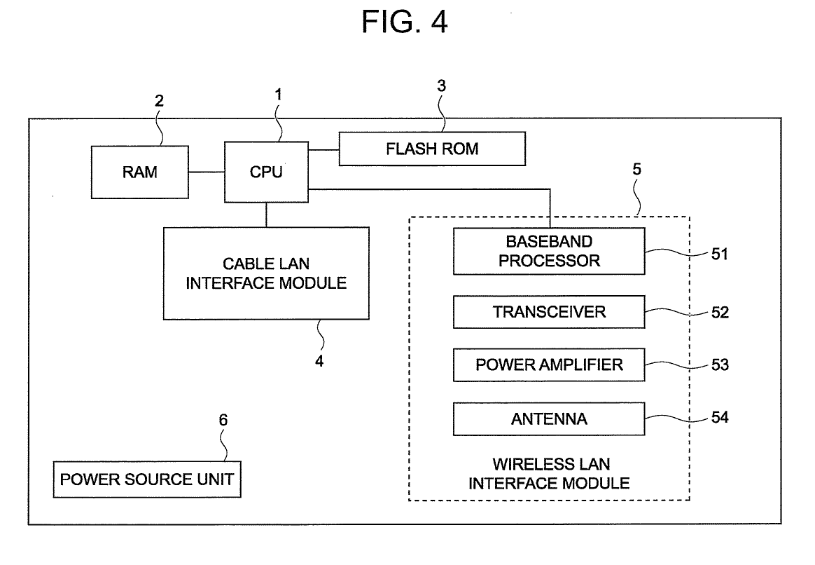

FIG. 4 illustrates a hardware configuration of the access point. The access point can be exemplified by a computer having a communication function via the cable LAN and a wireless communication function. As illustrated in FIG. 4, the access point includes a CPU 1, a RAM 2, a flash ROM 3, a cable LAN interface module 4 and a wireless LAN interface module 5.

The CPU 1 executes a computer program loaded into the RAM 2, thereby realizing the functions of the access point A, i.e., the cable LAN communication function, the wireless LAN communication function, etc.

The RAM 2 retains the computer program executed by the CPU 1 or data processed by the CPU 1. On the other hand, the flash ROM 3 retains, e.g., a pre-loading computer program, the MAC (Media Access Control) addresses on the cable LAN and the wireless LAN, or the data such as the SSID.

The cable LAN L1 interface module 4 (corresponding to a point-to-point communication unit) provides the communication function with respect to a node on the network by, e.g., a CSMA/CD (Carrier Sense Multiple Access with Collision Detection) method. Note that the embodiment exemplifies the cable LAN interface module 4 by way of the point-to-point communication unit. The point-to-point communication unit may, however, take other configurations such as a telephone line, an optical network and a public digital line.

The wireless LAN interface module 5 (corresponding to a wireless communication unit) provides the communication function with respect to the wireless LAN terminal through the radio signals by a CSMA/CA (Carrier Sense Multiple Access with Collision Avoidance) method. The wireless LAN interface module 5 includes, e.g., a baseband processor 51, a transceiver 52, a power amplifier 53 and an antenna 54. For example, the baseband processor 51 executes, e.g., CSMA/CA control, a digital modulation/demodulation process, an error correction process, etc. Further, the transceiver 52 executes a frequency conversion between a baseband signal and a radio frequency.

The power amplifier 53 amplifies the signals converted into the radio frequency. The thus-amplified signals of the radio frequency are radiated from the antenna 54. Moreover, the power amplifier 53 amplifies the radio frequency signals received from the antenna 54 and transfers the amplified radio frequency signals to the transceiver 52. A power source unit 6 supplies the electric power to the respective components of the access point.

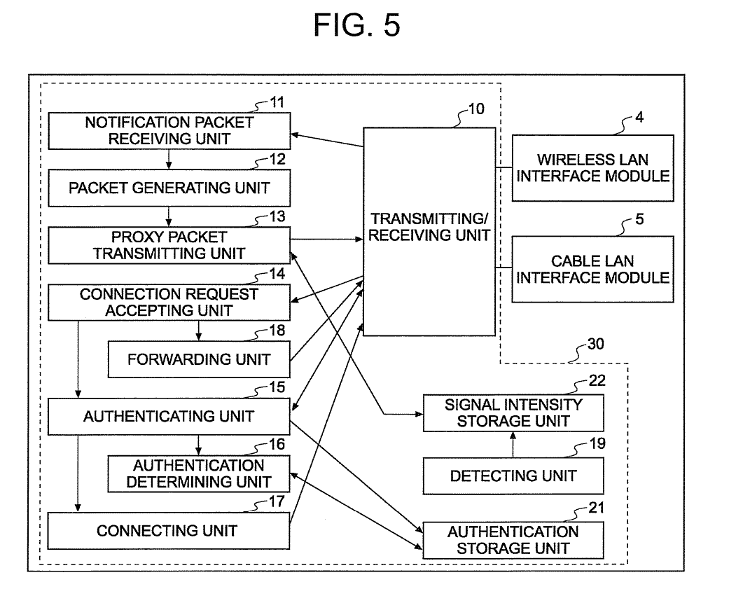

FIG. 5 illustrates a function block configured by the computer program on the CPU of the access point and by hardware components of the access point. As in FIG. 5, the access point includes a control unit 30, the cable LAN interface module 4 and the wireless LAN interface module 5. Further, the control unit 30 includes a transmitting/receiving unit 10, a notification packet receiving unit 11, a packet generating unit 12, a proxy packet generating unit 13, a connection request accepting unit 14, an authenticating unit 15, an authentication determining unit 16, a connecting unit 17 and an authentication storage unit 21.

The transmitting/receiving unit 10 transmits and receives the information between another access point and the wireless LAN terminal via the cable LAN interface module 4 and the wireless LAN interface module 5. The transmitting/receiving unit 10 includes, e.g., a device driver of the cable LAN interface module 4, a device driver of the wireless LAN interface module 5, protocol processing units of a network layer and an upper layer thereof, etc.

The information transmitted and received by the transmitting/receiving unit 10 contains the notification packet defined as a transmission request of the proxy packet sent from another access point, and an authentication request sent from the wireless LAN terminal and received by the wireless LAN interface module 5 of the self-device or by another access point. The transmitting/receiving unit 10 allocates received pieces of information to the notification packet receiving unit 11 and the authenticating unit 15.

The notification packet receiving unit 11 (corresponding to a unit to receive identifying information) receives the notification packet from another access point via the cable LAN interface module 4 and the transmitting/receiving unit 10. The notification packet contains the MAC address defined as the identifying information for identifying the sender access point on the wireless LAN.

The packet generating unit 12 (corresponding to packet generating unit) generates the proxy packet serving as a substitute for a terminal guide packet from another access point as the sender access point by use of the received MAC address.

The proxy packet transmitting unit 13 (corresponding to transmitting unit) transmits the generated proxy packet via the cable LAN interface module 4.

The connection request accepting unit 14 (corresponding to a unit to receive a connection request) accepts the authentication request from the wireless LAN terminal C via the cable LAN interface module 5. This authentication request is classified into an authentication request with respect to the Beacon packet sent from the access point and an authentication request with respect to the proxy packet. Note that the term “authentication request” might be referred to as a “connection request” in the sense that the authentication request is a request for the connection to the wireless LAN.

The connection request accepting unit 14 requests a forwarding unit 18 (corresponding to forwarding unit) to forward the authentication request with respect to the proxy packet. The forwarding unit 18 reads identifying information (target address) as an original address from the authentication request, and forwards the authentication request to the access point specified by the target address via the transmitting/receiving unit 10 and the cable LAN interface module 4.

On the other hand, when the authentication request is the authentication request for the self-device with respect to the Beacon packet, the connection request accepting unit 14 requests the authenticating unit 15 (corresponding to a unit to authenticate) to make the authentication in response to the authentication request. The authenticating unit 15 determines through the authentication determining unit 16 (corresponding to a unit to determine) whether the wireless LAN terminal C defined as the authentication requester has already been authenticated or not. If the wireless LAN terminal C has already been authenticated, the authentication storage unit 21 (corresponding to authentication storage unit) is recorded with the identifying information (wireless MAC address) of the wireless LAN terminal C. The authentication determining unit 16 determines whether or not the sender identifying information contained in the authentication request is stored in the authentication storage unit 21. The authenticating unit 15 is notified of a result of this determination.

If the wireless LAN terminal C has already been authenticated, the authenticating unit 15 indicates this purport to the connecting unit 17. With this indication, the wireless LAN terminal C is permitted to connect with the wireless LAN system, thus becoming a connected status. Whereas if the wireless LAN terminal C is not yet authenticated, the authenticating unit 15 requests the RADIUS server 8 to authenticate the wireless LAN terminal C via the LAN through the cable LAN interface module 4. Upon completing the authentication, the authenticating unit 15 deems that the identifying information of the wireless LAN terminal C has already been authenticated and stores this identifying information in the authentication storage unit 21. Then, the authenticating unit 15 indicates this purport to the connecting unit 17. With this indication, the connecting unit 17 newly permits the wireless LAN terminal C to connect with the wireless LAN system.

Incidentally, the process is executed also in such a case that the authentication request with respect to the proxy packet issued by another access point in place of the self-device is forwarded to the self-device from the recipient access point. Namely, the forwarded authentication request is forwarded to the authenticating unit 15 via the cable LAN interface module 4 and the transmitting/receiving unit 10. The authenticating unit 15 requests the RADIUS server 8 to make the authentication in response to the forwarded authentication request also. This procedure is known as the pre-authentication process. As a result of being previously authenticated, the identifying information of the wireless LAN terminal authenticated by the RADIUS server 8 is also stored in the authentication storage unit 21.

The access point in the embodiment further includes a detecting unit 19 which detects a signal intensity of the Beacon packet sent from another access point and a signal intensity storage unit 22 stored with the detected signal intensity on a per-access-point basis. To be specific, the detecting unit 19 detects the signal intensity of the Beacon packet sent from another access point via the wireless LAN interface module 5 at a predetermined interval. Then, the detecting unit 19 gets the signal intensity storage unit 22 to store the detected signal intensity of the Beacon packet and the sender identifying information (MAC address) of the Beacon packet.

Then, the proxy packet transmitting unit 13 determines, before transmitting the proxy packet, whether or not the signal intensity storage unit 22 is stored with the identifying information of the access point serving as the proxy with this proxy packet. Subsequently, if the identifying information is stored in the signal intensity storage unit 22 and if the signal intensity is equal to or larger then a predetermined limit value, the proxy packet transmitting unit 13 does not transmit the proxy packet. This is because even if the proxy packet does not exist, the Beacon packet of this access point can sufficiently reach the wireless LAN terminal.

<Unit Etc.>

The control unit 30, the cable LAN interface module 4, the wireless LAN interface module 5, etc explained above or the components illustrated in FIGS. 4 and 5 may be respectively described by the term, e.g., “Unit”. Herein, the “Unit” includes a module, a table, etc. and is realized by the following software component or hardware component. The “Unit” is not, however, restricted to the example given below.

Namely, the “Unit” is exemplified by an Field Programmable Gate Array (FPGA), an Application Specific Integrated Circuit (ASIC), a gate array, a combination of logic gates, a signal processing circuit, an analog circuit and other electric circuit networks, and includes elements which realize functions of these respective components described above. The logic gate may include an AND, an OR, a NOT, a NAND, a NOR, a flip-flop, a counter circuit and so on. The signal processing circuit may include circuit elements which execute, e.g., addition, multiplication, subtraction (inversion), a sum-of-products operation, differentiation and integration of signal values. Further, the analog circuit may include circuit elements which execute amplification, addition, multiplication, differentiation and integration.

It is effective that the software unit, e.g., the software module is loaded into the storage device which is allocation-enabled by addresses (storage areas can be allocated based on addresses). In this case, the software module includes, for example, a software component, a procedure-oriented language based component, an object-oriented software component, class component, a component managed as a task, a component managed as a process, and elements (components) such as a function, an attribute, a procedure (referred to also as a Procedure), a subroutine (referred to also as a software routine), a fragment or segment of a program code, a driver, firmware, a microcode, data, a database, a data structure, a table, an array, a variable and a parameter. These components have the respective functions, and a component attaining a further function is realized by combining the plurality of those components. Conversely, the function or the element realized by each unit is further fragmented, and each unit may also be actualized by combining a plurality of low-order units. Moreover, these components are realized on a processing device(s) such as one or a plurality of CPUs or a DSPs (Digital Signal Processors).

The software module can be described in a C-language, C++, Java®, Visual Basic®, or other many programming languages. These software modules can be stored in one or a plurality of storage devices, readable by a machine (or computer), such as a dynamic random access memory (DRAM), a static random access memory (SRAM), electronically erasable and a programmable read only memory (EEPROM), a flash memory and a memory card including any one of these memories; a magnetic disk such as a hard disk, a flexible disk (Floppy (registered trademark) etc) and other attachable/detachable disk mediums; other magnetic mediums such as a tape; and an optical medium such as a compact disc (CD) and a DVD (Digital Video Disk or Digital Versatile Disk). Instructions contained in the software unit or software module can be, however, forwarded to or loaded into and executed by the machine or the device such as the computer with a cable network card via the cable network or with a wireless card via the wireless network. Then, the execution of these instructions realizes the software units or the software modules having the functions corresponding to these instructions. In such a forwarding process or loading process, the data signals are forwarded across the cable network or wireless network in the way of their being embodied as, e.g., carrier waves. There might be, however, a case in which the data signals are forwarded intact as so-called baseband signals without depending on the carrier waves. Herein, the cable network or the wireless network is a network built up by, e.g., a telephone line, a network line, a cable (including an optical cable and a metallic cable), a wireless link, a mobile phone access line, a PHS (Personal Handyphone System) network, a wireless LAN (Local Area Network), Bluetooth, or on-vehicle wireless type communications (including vehicle-to-on-road-device communications and vehicle-to-vehicle communications) such as DSRC (Dedicated Short Range Communication). Then, the data signals are transmitted to convey the information containing the instruction, the code and the data to a node or the component on the network. These carrier waves adopt an electric mode, a magnetic mode, an optical mode, an acoustic mode, an electromagnetic mode, or other types of signal modes.

Moreover, any one of the functions described above can be realized in the way of being coded (and thus stored) on the recording medium readable by the computer and other machines or devices (which will hereinafter be referred to as a computer etc). Then, the computer etc is made to read the program from the recording medium and execute the program, thereby enabling the function thereof to be provided.

Herein, the recording medium readable by the computer connotes a recording medium capable of storing information such as data and programs electrically, magnetically, optically, mechanically or by chemical action, which can be read from the computer. The mechanical action can be exemplified by forming a rugged portion on an emboss card or forming a punch-hole in the paper medium. The electrical, mechanical or physical action can be exemplified by writing the data to the element on the ROM constructed by use of a fuse and by a developing process of toners to form a latent image on the paper medium. The (information on the) paper medium may be read, e.g., optically. The physical or chemical action can be exemplified by forming a thin film or a rugged portion on a substrate. The (information on the) rugged port ion may be read, e.g., optically. The chemical action can be exemplified by oxidation-reduction reaction on the substrate or forming an oxide film or a nitride film on a semiconductor substrate, or development of a photo resist, and so on. Among these recording mediums, for example, a flexible disc, a magneto-optic disc, a CD-ROM, a CD-R/W, a DVD, a magnetic tape, a memory card and a storage device incorporating any one of these mediums are given as those demountable from the computer. The storage device is exemplified by a storage device which further has a built-in DRAM or SRAM.

Further, the hard disc, the DRAM, the SRAM, the ROM (Read-Only Memory), the EEPROM, the flash memory etc. are given as the recording mediums fixed within the computer.

Moreover, the recording mediums readable by the computer etc are exemplified by systems which are linked up via the network. The information containing the instruction, the code and the data, which are stored in the systems, is executed in a distributed processing environment.

The program, the instruction code and the code segment each realizing the function described above can be configured by an ordinary programmer in the field of the present technology. Furthermore, the electric circuit network realizing the function described above can be constructed by an ordinary circuit engineer in the field of the present technology.

<Data Structure>

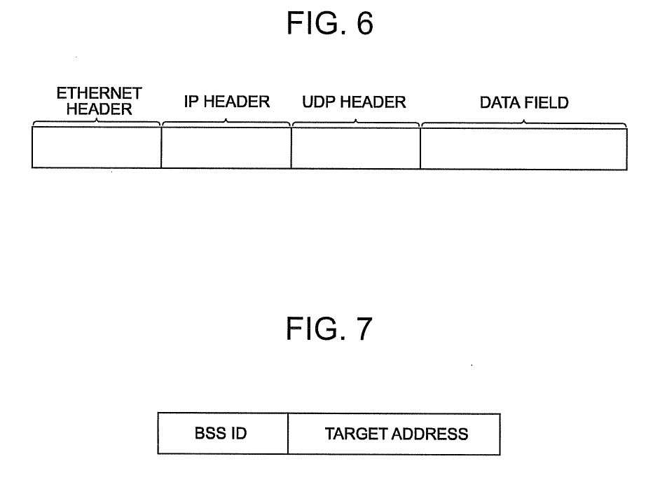

FIG. 6 illustrates an example of a data structure of a notification packet used when one access point requests another access point to transmit the proxy packet. Contents of respective headers and a data field (payload) are given as below.

Ethernet® Header:

An Ethernet® header contains the following information. Source MAC address: this address is the MAC address, on the wireless LAN, of the sender access point of the notification packet. Destination MAC address: herein, a Broadcast address (ff: ff: ff: ff: ff: ff) is designated as the Destination MAC address. Accordingly, the notification packet is transmitted to all the nodes on the segments of the cable LAN L1.

The notification packet is the broadcast packet having no necessity for a reply from the recipient. Therefore, the process on the original cable LAN L1 has no necessity for the Source MAC address. Such being the case, in the communication system, the MAC address, on the wireless LAN, of the sender access point of the notification packet is set in the Source MAC address of the notification packet.

The notification recipient receiving the notification packet reads the wireless LAN MAC address of the sender of the notification packet from the Source MAC address, and sets this address in the Beacon packet. Note that the wireless LAN MAC address of the sender of the notification packet is not necessarily set in the Source MAC address of the Ethernet® header. For example, this MAC address may be stored in the data field (payload).

IP header: an IP header contains the following information. Source IP address: this is the IP address of the sender access point of the notification packet. Destination IP address: Broadcast IP address (based on the network address) is designated as the Destination IP address.

UDP (User Datagram Protocol) header: a UDP header contains the following information. Source port number: a Source port number takes a certain predetermined value (such as 6350). Destination port number: a Destination port number takes a certain predetermined value (e.g., 6350 etc). Note that the Source port number and the Destination port number are not necessarily the same. In any case, it follows that the port number specifies the sender of the notification packet and a processing program of the IP layer on which the packet should be processed in each destination node.

Data field: the data field contains an identifier for identifying the notification packet. Supposing that a character string, e.g., “Notification” is set as the identifier, it follows that the data contains a hexadecimal data string “4e 6f 74 69 66 69 63 61 74 69 6f 6e” (“Notification”).

Note that if the wireless LAN MAC address of the sender is not contained in the Source MAC address of the Ethernet® header, this MAC address may be stored in the Data field.

FIG. 7 illustrates a structure of the destination address field of the authentication packet received by each access point from the wireless LAN terminal C. The authentication packet is a packet used for the wireless LAN terminal C to request the access point to make the authentication.

As in FIG. 7, in the embodiment, the destination address of the authentication packet is organized by a BSS (Basic Service Set) ID and a target address. The BSS ID is an address used for identifying the address of the packet at the physical level. On the other hand, the target address is an address which specifies an original address of the packet.

In the normal wireless LAN system, the same wireless MAC address is designated in the BSS ID and in the target address. The pre-authentication process, however, involves designating the access point (the current connecting destination) which receives the pre-authentication packet in the BSS ID and designating the access point of the pre-authentication destination (i.e., the not-yet-connected access point that should become the next connecting destination). When receiving the packet (which will hereinafter be generally termed a pre-authentication packet) containing a request for the pre-authentication such as this, the access point defined as the current connecting destination and specified by the BSS ID forwards the authentication packet to the access point associated with the wireless LAN address designated in the target address.

Accordingly, each access point retains, on the memory, a mapping table of the cable LAN MAC address of the forwarding destination with respect to the target address (the wireless LAN MAC address).

<Processing Flow>

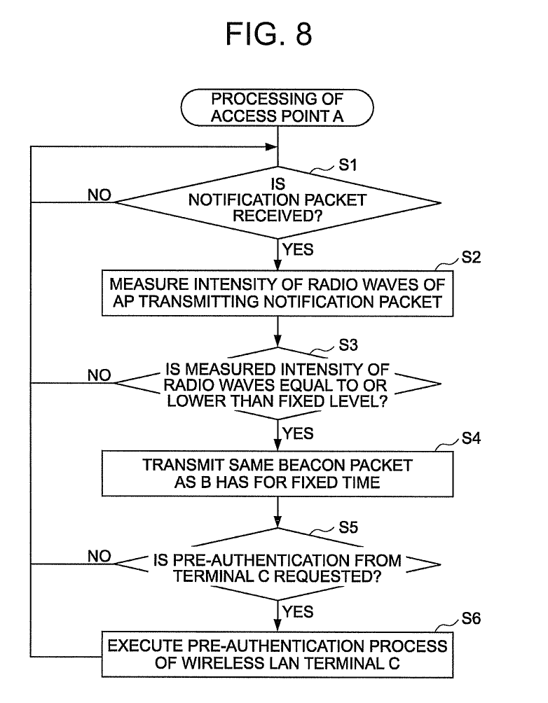

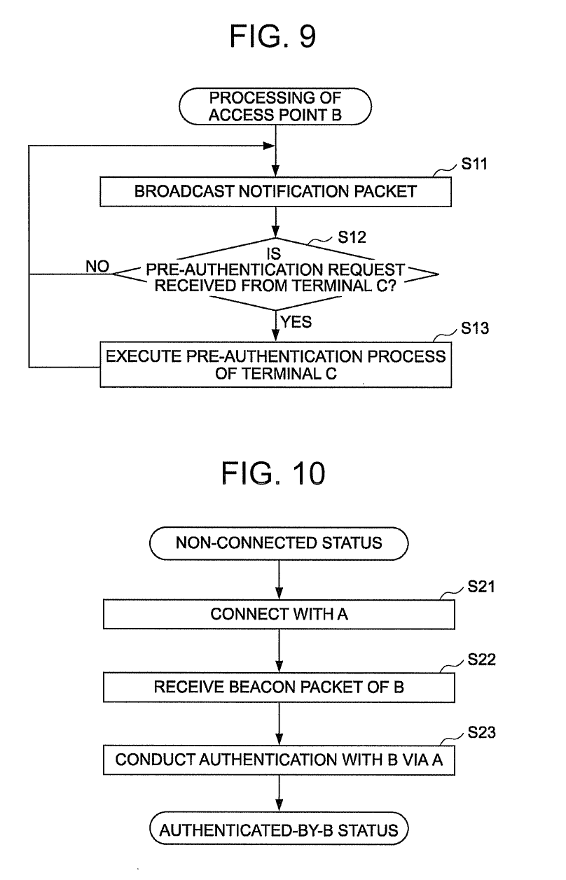

FIGS. 8 and 9 illustrate the processes at the access points A and B. These processes are actualized by the computer programs executed by the CPUs on the access points A, B. As already discussed above, however, at least some of these processes may be realized by the program on the DSP or by the hardware circuit.

In the embodiment, the access point A receives the notification packet from the access point B. Then, the access point A, in place of the access point B, transmits the Beacon packet equal to the Beacon packet that should be transmitted from the access point B. Incidentally, though the explanation is herein omitted, similarly the access points A, B execute the processes with their roles being exchanged. To be specific, upon receiving the notification packet from the access point A, the access point B, in place of the access point A, transmits the Beacon packet equal to the Beacon packet that should be transmitted from the access point A.

FIG. 8 illustrates the process at the access point A. In this process, normally, the access point A is in a standby status for receiving the notification packet from another access point B etc (S1, the receiving unit 10 in FIG. 5). Then, when receiving the notification packet, the access point A measures the signal intensity of the Beacon packet sent from the sender access point B of the notification packet (S2). The signal intensity can be determined from, e.g., an S/N (Signal/Noise) ratio after being amplified by the power amplifier depicted in FIG. 5.

The detecting unit 19 in FIG. 5 may, however, detect the signal intensity at the predetermined interval and may store the signal intensity in the signal intensity storage unit 22 on the per-access-point basis. In this case, it is enough that the access point A determines the signal intensity of the Beacon packet sent from the access point B according to the information in the signal intensity storage unit 22.

Then, if the signal intensity of the Beacon packet sent from the access point B is not equal to or lower than a fixed level, the Beacon packet has already reached from the sender of the notification packet, and hence the access point A does nothing but returns the control to S1.

Whereas if the signal intensity is equal to or lower than the fixed level, the access point A generates the same Beacon packet as the Beacon packet transmitted from the sender access point B of the notification packet (the packet generating unit 12 in FIG. 5). Then, the access point A transmits the same Beacon packet as (the Beacon packet transmitted) by the access point B (S4, the proxy packet transmitting unit 13 in FIG. 5). In this case, though not explicitly illustrated in FIG. 7, the access point A transmits its own Beacon packet and the same Beacon packet as the packet of the access point B in parallel on the time-division basis.

Next, the access point A determines whether the pre-authentication is requested by the wireless LAN terminal C or not (S5, the connection request accepting unit 14 in FIG. 5). Then, if the pre-authentication is requested, the access point A executes the pre-authentication process (S6).

Herein, the access point A recognizes that the target address of the authentication packet is not the address of the access point A but the address of the access point B. Then, the access point A forwards the information of this authentication packet to the access point B via the cable LAN L1 (the forwarding unit 18 in FIG. 5).

FIG. 9 illustrates the process at the access point B. In this process, the access point B broadcasts the notification packet to (all) the segments of the cable LAN L1 (S11).

Next, the access point B determines whether or not the pre-authentication request is received from the terminal C via another access point (S12). Then, in the case of receiving the pre-authentication request, the access point B executes the pre-authentication of the wireless LAN terminal C (S13, the authenticating unit 15 in FIG. 5). Thereafter, the wireless LAN terminal C loops the control backs to S11.

In this case, the access point B, when receiving the pre-authentication request of the wireless LAN terminal C, requests, based on this pre-authentication request, the RADIUS server 8 to authenticate the wireless LAN terminal C. Subsequently, when receiving from the RADIUS server 8 a response saying that the authentication of the wireless LAN terminal C gets successful, the access point B records the wireless LAN terminal C in an already-authenticated terminal table on the RAM 2 (the authentication storage unit 21 in FIG. 5). It should be noted that the already-authenticated terminal table is checked at an interval of a predetermined period, and an authentication status of the already-authenticated wireless LAN terminal receiving no access for the predetermined period is cleared.

FIG. 10 illustrates a processing flow of the pre-authentication process. In this pre-authentication process, the processing flow represents a process of the pre-authentication requester wireless LAN terminal C, a process of the current connecting target access point A of the wireless LAN terminal C and a process of the pre-authentication target access point B.

To start with, the wireless LAN terminal C connects with the access point A (S21). This process involves the same procedure as the procedure with respect to the normal wireless LAN access point. Next, the wireless LAN terminal C receives the Beacon packet of the access point B from the access point A (S22).

Then, the wireless LAN terminal C designates the (address of the) currently-connected access point A in the BSS ID (BSS ID field) and the (address of the) access point B in the target address (TARGET ADDRESS field), and thus transmits the authentication packet for the pre-authentication request. The authentication packet is thereby forwarded to the access point B from the access point A, thereby executing the pre-authentication.

<Effect of System>

Through the processes described above, the connecting target access point can be smoothly changed, and it is feasible to reduce a decline of the communication quality and an intermittent communication, which occur when changing the connecting target access point.

Namely, the wireless LAN terminal C can receive the Beacon packet from the access point B via the access point A even in the area where the Beacon packet can not be originally received from the access point B. Then, the pre-authentication request can be given to the access point B via the access point A. Namely, the pre-authentication can be executed in the area that is still more expanded than by the conventional process.

### Outline of Modified Example

In the embodiment discussed above, if the Beacon packet sent from the access point (e.g., B) itself that has made the request for transmitting the Beacon packet has a sufficiently strong intensity, the access point (e.g., A) receiving the request does not transmit the Beacon packet. In addition to this case, there exists a case of desiring to proxy-transmit only the Beacon packet of the specified access point or only the Beacon packets of the access point group when executing the proxy-transmission of the Beacon packet. This includes, e.g., the following cases. (1) A case of desiring to proxy-transmit, with the moving route of the wireless LAN terminal being determined, only the Beacon packets of the access points disposed along this route. (2) A case of desiring to exclude the access point disposed in a physically near place having a high possibility that the Beacon packet directly reaches the wireless LAN terminal from the proxy transmission target access points. Herein, modified examples corresponding to the respective cases will be discussed.

### Modified Example of Case of Performing Proxy-Transmission about only Specified Access Point

It is assumed that each access point holds an “area ID” by way of its own setting. It is also assumed that the access points about which the wireless LAN terminals try to execute the pre-authentication process hold the same area ID mutually. It is sufficient that the area ID is stored in, e.g., the flash ROM 3 (corresponding to area storage unit).

The “notification packet” transmitted from each access point is transmitted in the form of containing this area ID, and the access point receiving the notification packet proxy-transmits the Beacon packet with respect to only the notification packet containing the same area ID as its own area ID. The area ID may be stored in the data field in FIG. 6.

The access points holding the same area ID are disposed along the moving route of the wireless LAN terminal, thereby enabling the pre-authentication process to be executed within only a necessary range and enabling the transmission of the futile Beacon packets and the futile authenticating operations to be prevented.

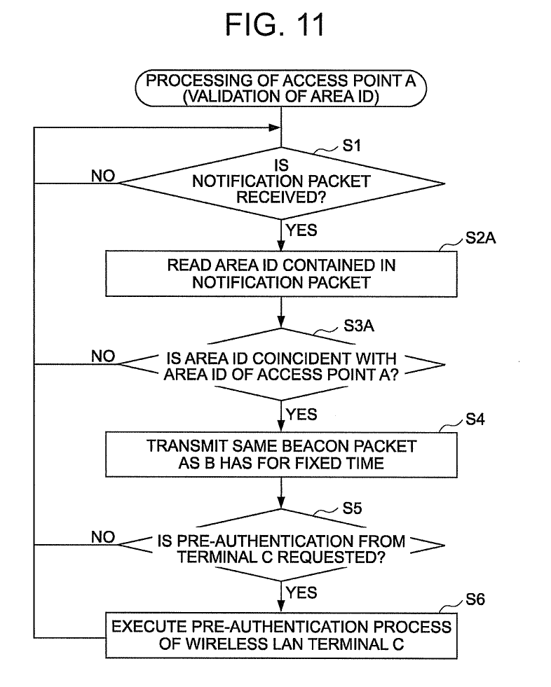

FIG. 11 illustrates a processing flow of the access point which transmits the proxy packet in place of the specified access point. This processing is different from the processing in FIG. 8 in terms of processes in S2A and S3A.

To be specific, upon receiving the notification packet, the access point A reads the area ID of the sender access point of the notification packet from this notification packet (S2A).

Then, it is determined whether or not the readout area ID is coincident with the area ID of the access point A (S3A). Subsequently, if the area ID (stored) in the notification packet is not coincident with the area ID of the access point, the packet is the notification packet sent from the access point located outside the range where originally the Beacon packet should be proxy-transmitted, and hence the access point A executes nothing but loops the control back to S1.

On the other hand, if the area ID in the notification packet with the measurement being done is coincident with the area ID of the access point A, the access point A generates the same Beacon packet as the Beacon packet transmitted from the sender access point B of the notification packet. The subsequent processes are the same as those in FIG. 8 and are therefore omitted (in terms of their explanations).

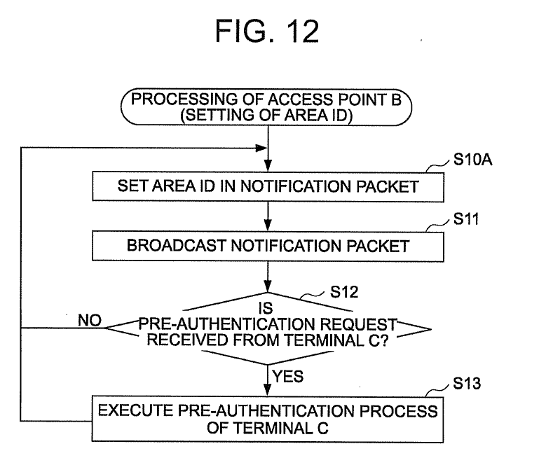

FIG. 12 illustrates the processing of the sender (access point B) which attaches the area ID to the notification packet, corresponding to the access point A described above. This processing is different from the processing in FIG. 9 in terms of a process in S10A.

Specifically, the access point B sets the area ID in the notification packet (S10A). The access point B broadcasts the notification packet to the segments of the cable LAN L1 (S11). The notification packet with the area ID being specified is thereby transmitted to other access points.

Through the processes described above, it is feasible to execute the pre-authentication process only within the necessary range and prevent the futile Beacon packets from being transmitted and the futile authenticating operation from being conducted.

Incidentally, reversely to what has been described above, with respect to the notification packet containing the same area ID, the Beacon packet may not be proxy-transmitted. This process is effective in an environment where the access points holding the same area ID are sufficiently close to each other and can transmit the Beacon packets mutually in duplex to the wireless LAN terminal.

<Case of Excluding Physically Near Access Point from Proxy-Transmission Targets>

The text of the present invention has discussed, by way of one working example for excluding the physically near access point from the proxy-transmission target access points, the method of measuring the signal intensify of the radio waves transmitted from the access point that has transmitted the notification packet and, in the case of observing the reception signal intensity equal to or larger than the fixed value, not performing the proxy-transmission, however, another working example will be herein described.

System time held by the respective access points are previously synchronized with high accuracy. The synchronizing method involves, it is considered, utilizing NTP (Network Time Protocol). Then, information on a packet transmission time is embedded in the notification packet.

The access point receiving the notification packet compares the system time held by the access point itself with the packet transmission time contained in the notification packet, then, if the time difference between them is equal to or larger than a fixed value, judges the sender of the received notification packet as the “near access point”, and does not conduct the proxy-transmission of the Beacon packet. Whereas if the time difference equal to or larger than the fixed value, a presumable reason may be that the packet passes through several hubs, the access point judges the sender as the “far access point” and conducts the proxy-transmission of the Beacon packet.

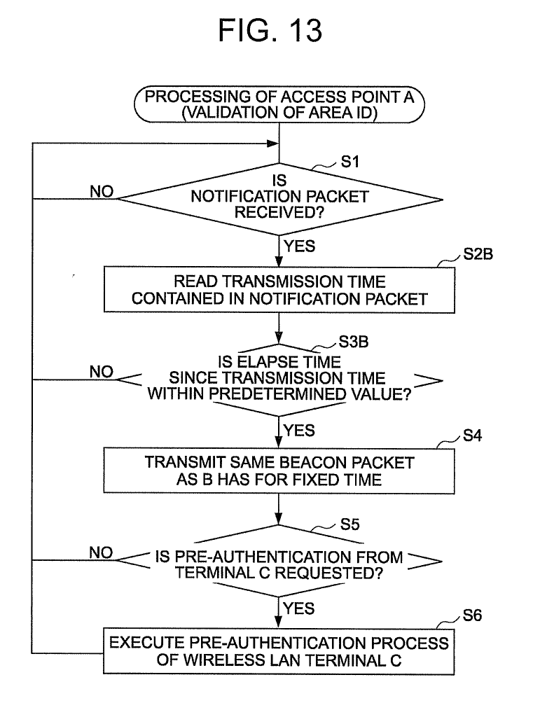

FIG. 13 illustrates processing of the access point A which transmits the proxy packet as a substitute for the Beacon packet of the sender (access point B) of the notification packet after checking the time difference. This processing is different from the processing in FIG. 8 in terms of processes in S2B and S3B.

To be specific, upon receiving the notification packet, the access point A reads the transmission time contained in the notification packet (S2B).

Then, the access point A calculates, from the readout transmission time and the present time, elapse time after the notification packet has been transmitted (the CPU 1 executing this process corresponds to a unit to calculate transmission time). Subsequently, the access point A determines whether the elapse time from the transmission time is within a predetermined value or not (S3B). Then, if the elapse time from the transmission time is within the predetermined value, the packet is the notification packet from the access point located outside the range where originally the Beacon packet should be proxy-transmitted, and therefore the access point A executes nothing but loops the control back to S1.

Whereas if the elapse time from the transmission time is not within the predetermined value, the access point A generates the same Beacon packet as the Beacon packet transmitted from the sender access point B of the notification packet. The subsequent processes are the same as those in FIG. 8 and are therefore omitted.

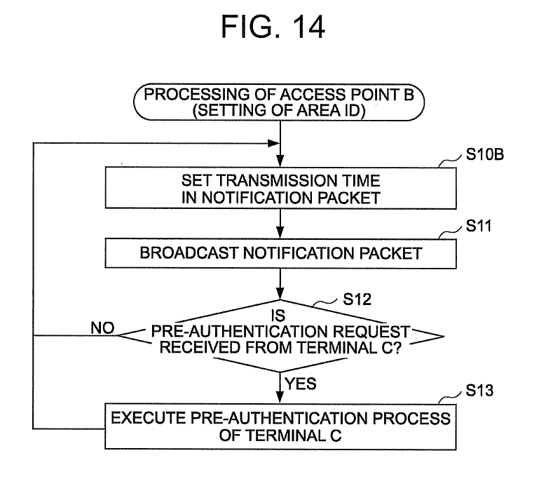

FIG. 14 illustrates processing of the sender (access point B) which attaches the transmission time to the notification packet, corresponding to the access point A described above. This processing is different from the processing in FIG. 9 in terms of a process in S10B.

Specifically, the access point B sets the transmission time (transmission schedule time) in the notification packet (S10B). Then, the access point B broadcasts the notification packet to the segments of the cable LAN L1 at the transmission schedule time (S11). With this scheme, it follows that the notification packet with the transmission time being specified is broadcasted to other access points.

Through the processes described above, it is feasible to execute the pre-authentication process only within the necessary range and prevent the futile Beacon packets from being transmitted and the futile authenticating operation from being conducted.

### Modified Example

The embodiment discussed above has exemplified the processing in the case where the common SSID is held between the plurality of access points. The implementation of the present invention is not, however, limited to the configuration such as this. Namely, the transmission/reception of the notification packet, the transmission of the proxy packet and the pre-authentication process may be executed in the same procedures as those described above between the plurality of access points having the SSIDs different from each other. In this case, however, the SSID of the requester (the sender of the notification packet) is contained in the notification packet, and the requested access point may set the SSID read from the notification packet in the proxy packet.

Moreover, the SSID of the requester (the sender of the notification packet) is contained in the notification packet, and the proxy packet may also be transmitted in response to only the request given from the access point having the SSID common to the self-device. In this case, in the environment where the plurality of access points having the different SSIDs exists, similarly to the embodiment discussed above, the communication system is realized, in which the access point having the common SSID transmits the proxy packet.

### Other Modified Examples

The embodiment discussed above has exemplified the system including the access point on the wireless LAN and the wireless LAN terminal connected to the wireless LAN via this access point. The communication system is not, however, limited to the system including the wireless LAN. Namely, the communication system can be actualized by the general type of wireless networks which support the pre-authentication process. Further, the wirelessly-connected device is not restricted to the wireless LAN terminal but targets the general type of information equipment having the wireless connection function such as the game machine, the non-vehicle device, the personal computer, the PHS and the mobile phone.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A wireless connection device included in a wireless network system, comprising:
a point-to-point communication unit to perform communications with another wireless connection device;
a wireless communication unit to transmit a wireless device guide packet to a wireless device and to accept an access request from said wireless device; and
a control unit,
said control unit including:
a unit to receive a proxy request containing identifying information for identifying another wireless connection device when in wireless communications from said another wireless connection device via said point-to-point communication unit;
a packet generating unit to generate a proxy packet as a substitute for the wireless device guide packet sent from said another wireless connection device serving as a sender of this wireless device guide packet by use of the received identifying information;
a transmitting unit to transmit the proxy packet via said wireless communication unit;
a unit to accept a request for the connection to said wireless network system from said wireless device; and
a forwarding unit to forward the connection request to said another wireless connection device via said point-to-point communication unit when the accepted connection request is a connection request addressed to said another wireless connection device.

2. The wireless connection device included in a wireless network system according to claim 1, wherein said control unit further includes:
a unit to receive the connection request addressed to a self-device from said wireless device via said another wireless connection device;
a unit to authenticate said wireless device which transmits the connection request via said another wireless connection device when receiving the connection request;
an authentication storage unit to store the identifying information of said already-authenticated wireless device;
a unit to determine whether or not said wireless device has already been authenticated by said wireless connection device by referring to said authentication storage unit on the basis of the identifying information when the connection request is given from said wireless device via said wireless communication unit; and
a connecting unit to permit the connection of said already-authenticated wireless device as a result of the determination without further executing an authentication process.

3. The wireless connection device included in a wireless network system according to claim 1, further comprising a detecting unit to detect an signal intensity of the wireless device guide packet sent from said another wireless connection device,
wherein said control unit, if the detected signal intensity of a searching target packet from said another wireless connection device is stronger than a predetermined value, does not transmit the proxy packet even when receiving the proxy request from said another wireless connection device.

4. The wireless connection device included in a wireless network system according to claim 1, further comprising an area storage unit to identify an area where said self-device is located when segmenting a range covered by said wireless network system into a plurality of areas,
wherein said another wireless connection device transmits, together with the proxy request, the area identifying information of the area where said another wireless connection device is located, and
said control unit, even when receiving the proxy request from said another wireless connection device and if the area identifying information of the area where said self-device is located is not coincident with the area identifying information of the area where said another wireless connection device is located, does not transmit the proxy packet.

5. The wireless connection device included in a wireless network system according to claim 1, wherein said another wireless connection device attaches a transmission time to the proxy request and transmits the proxy request at this transmission time,
said control unit includes a unit to calculate a period of transmission time expended for transmitting the proxy request from the time when receiving the proxy request and from the transmission time attached to the proxy request, and
even when receiving the proxy request from said another wireless connection device and if a position of said another wireless connection device is determined to be within a predetermined range away from said self-device on the basis of the period of transmission time, the proxy packet is not transmitted.

6. A processing method executed by a wireless connection device included in a wireless network system, said method comprising:
receiving a proxy request containing identifying information for identifying another wireless connection device when in wireless communications from said another wireless connection device via said point-to-point communication unit via a point-to-point communication unit to perform communications with another wireless connection device;
generating a proxy packet as a substitute for the wireless device guide packet sent from said another wireless connection device serving as a sender of this wireless device guide packet by use of the received identifying information;
transmitting the proxy packet via said wireless communication unit;
accepting a request for the connection to said wireless network system from said wireless device; and
forwarding the connection request to said another wireless connection device when the accepted connection request is a connection request addressed to said another wireless connection device.

7. The processing method according to claim 6, further comprising:
receiving the connection request addressed to a self-device from said wireless device via said another wireless connection device;
authenticating said wireless device which transmits the connection request when receiving the connection request;
determining whether or not said wireless device has already been authenticated by said wireless connection device by referring to said authentication storage a unit to store the identifying information of said already-authenticated wireless device on the basis of the identifying information when the connection request is given from said wireless device via said wireless communication unit; and
permitting the connection of said already-authenticated wireless device as a result of the determination without further executing an authentication process.

8. The processing method according to claim 6, further comprising:
detecting an signal intensity of the wireless device guide packet sent from said another wireless connection device; and
stopping, if the detected signal intensity of a searching target packet from said another wireless connection device is stronger than a predetermined value, the transmission in said transmitting even when receiving the proxy request from said another wireless connection device.

9. The processing method according to claim 6, further comprising:
reading, from area storage unit, an area identifying information for identifying an area where said self-device is located when segmenting a range covered by said wireless network system into a plurality of areas;
receiving, together with the proxy request, the area identifying information of the area where said another wireless connection device is located; and
stopping, even when receiving the proxy request from said another wireless connection device and if the area identifying information of the area where said self-device is located is not coincident with the area identifying information of the area where said another wireless connection device is located, the transmission in the transmitting.

10. The processing method according to claim 6, further comprising:
receiving a transmission time when transmitting the proxy request together with the proxy request;
calculating a period of transmission time expended for transmitting the proxy request from the time when receiving the proxy request and from the transmission time attached to the proxy request; and
stopping, even when receiving the proxy request from said another wireless connection device and if a position of said another wireless connection device is determined to be within a predetermined range away from said self-device on the basis of the period of transmission time, the transmission in the transmitting.

11. A computer readable storage medium stored with a program making a wireless connection device included in a wireless network system perform:
receiving a proxy request containing identifying information for identifying another wireless connection device when in wireless communications from said another wireless connection device via said point-to-point communication unit via a point-to-point communication unit to perform communications with another wireless connection device;
generating a proxy packet as a substitute for the wireless device guide packet sent from said another wireless connection device serving as a sender of this wireless device guide packet by use of the received identifying information;
transmitting the proxy packet via said wireless communication unit;
accepting a request for the connection to said wireless network system from said wireless device; and
forwarding the connection request to said another wireless connection device when the accepted connection request is a connection request addressed to said another wireless connection device.

12. The computer readable storage medium according to claim 11, the program further makes said wireless connection device perform:
receiving the connection request addressed to a self-device from said wireless device via said another wireless connection device;
authenticating said wireless device which transmits the connection request when receiving the connection request;
determining whether or not said wireless device has already been authenticated by said wireless connection device by referring to said authentication storage a unit to store the identifying information of said already-authenticated wireless device on the basis of the identifying information when the connection request is given from said wireless device via said wireless communication unit; and
permitting the connection of said already-authenticated wireless device as a result of the determination without further executing an authentication process.

13. The computer readable storage medium according to claim 11, said program further makes said wireless connection device perform:
detecting an signal intensity of the wireless device guide packet sent from said another wireless connection device; and
stopping, if the detected signal intensity of a searching target packet from said another wireless connection device is stronger than a predetermined value, the transmission in the transmitting even when receiving the proxy request from said another wireless connection device.

14. The computer readable storage medium according to claim 11, said program further makes said wireless connection device perform:
reading, from area storage unit, an area identifying information for identifying an area where said self-device is located when segmenting a range covered by said wireless network system into a plurality of areas;
receiving, together with the proxy request, the area identifying information of the area where said another wireless connection device is located; and
stopping, even when receiving the proxy request from said another wireless connection device and if the area identifying information of the area where said self-device is located is not coincident with the area identifying information of the area where said another wireless connection device is located, the transmission in the transmitting.

15. The computer readable storage medium according to claim 11, said program further makes said wireless connection device perform:
receiving a transmission time when transmitting the proxy request together with the proxy request;
calculating a period of transmission time expended for transmitting the proxy request from the time when receiving the proxy request and from the transmission time attached to the proxy request; and
stopping, even when receiving the proxy request from said another wireless connection device and if a position of said another wireless connection device is determined to be within a predetermined range away from said self-device on the basis of the period of transmission time, the transmission in the transmitting.
